(19) United States
(12) Patent Application Publication
(10) Pub. No.: US 2025/0377874 A1
(43) Pub. Date: Dec. 11, 2025

(54) CODE OPTIMIZATION DEVICE, CODE OPTIMIZATION METHOD, AND RECORDING MEDIUM

(71) Applicant: NEC Corporation, Tokyo (JP)

(72) Inventors: Takuya ARAKI, Tokyo (JP); Osamu DAIDO, Tokyo (JP)

(73) Assignee: NEC Corporation, Tokyo (JP)

(21) Appl. No.: 19/227,706

(22) Filed: Jun. 4, 2025

(30) Foreign Application Priority Data
Jun. 11, 2024 (JP) 2024-094440

(51) Int. Cl. G06F 8/41; G06F 8/35; G06F 8/72

(52) U.S. Cl. CPC G06F 8/443; G06F 8/35; G06F 8/72

(57) ABSTRACT

A code optimization device includes an acquisition unit, a selection unit, an optimization unit, and an output unit. The acquisition unit acquires a code, of a program, to be optimized. The selection unit selects an optimization pattern to be applied to a code to be optimized from a plurality of optimization patterns that is information indicating the content of optimization of the code. The optimization unit optimizes a code to be optimized using a language model for optimizing the code based on a prompt for instructing optimization of the code using the selected optimization pattern. The output unit outputs the optimized code.

This application is based upon and claims the benefit of priority from Japanese Patent Application No. 2024-94440, filed on Jun. 11, 2024 the disclosure of which is incorporated herein in its entirety by reference.

### TECHNICAL FIELD

The present disclosure relates to a code optimization device and the like.

### BACKGROUND ART

Optimization of the code of the program may require a lot of workload and techniques related to optimization. For this reason, a system that supports creation of a code may be used. For example, a processor of PTL 1 (JP 2023-47334 A) extracts metadata regarding a program to be generated. The processor of PTL 1 generates a code of the program using the metadata as an input of the language model.

### SUMMARY

An object of the present disclosure is to provide a code optimization device and the like that can easily optimize a code of a program.

A code optimization device according to an aspect of the present disclosure includes an acquisition unit that acquires a code, of a program, to be optimized, a selection unit that selects an optimization pattern to be applied to the code to be optimized from a plurality of optimization patterns that is information indicating content of optimization of a code, an optimization unit that optimizes the code to be optimized using a language model that optimizes a code based on a prompt to instruct optimization of a code using the selected optimization pattern, and an output unit that outputs the optimized code.

A code optimization method according to an aspect of the present disclosure includes acquiring a code, of a program, to be optimized, selecting an optimization pattern to be applied to the code to be optimized from a plurality of optimization patterns that is information indicating content of optimization of a code, optimizing the code to be optimized using a language model that optimizes a code based on a prompt to instruct optimization of a code using the selected optimization pattern, and outputting the optimized code.

A recording medium according to an aspect of the present disclosure non-transitorily records a code optimization program for causing a computer to execute the steps of acquiring a code, of a program, to be optimized, selecting an optimization pattern to be applied to the code to be optimized from a plurality of optimization patterns that is information indicating content of optimization of a code, optimizing the code to be optimized using a language model that optimizes a code based on a prompt to instruct optimization of a code using the selected optimization pattern, and outputting the optimized code.

### BRIEF DESCRIPTION OF THE DRAWINGS

Exemplary features and advantages of the present disclosure will become apparent from the following detailed description when taken with the accompanying drawings in which:

FIG. 1 is a diagram illustrating an example of a configuration of a code optimization system according to the example embodiment of the present disclosure;

FIG. 2 is a diagram illustrating an example of a configuration of a code optimization device according to the example embodiment of the present disclosure;

FIG. 3 is a diagram illustrating an example of a configuration of a code optimization system according to the example embodiment of the present disclosure;

FIG. 4 is a diagram illustrating an example of a display screen according to the example embodiment of the present disclosure;

FIG. 5 is a diagram illustrating an example of a display screen according to the example embodiment of the present disclosure;

FIG. 6 is a diagram illustrating an example of an operation flow of the code optimization device according to the example embodiment of the present disclosure; and

FIG. 7 is a diagram illustrating an example of a hardware configuration of the code optimization device according to the example embodiment of the present disclosure.

### EXAMPLE EMBODIMENT

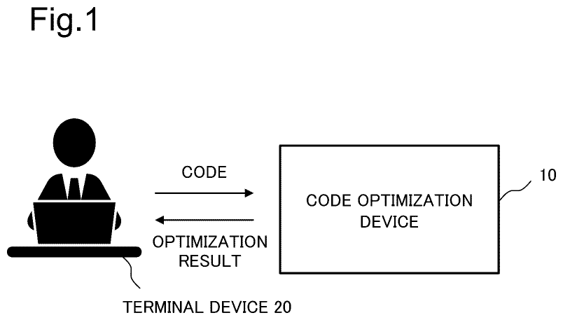

Example embodiments of the present disclosure will be described in detail with reference to the drawings. FIG. 1 is a diagram illustrating an example of a configuration of a code optimization system. The code optimization system includes, for example, a code optimization device 10 and a terminal device 20. The code optimization device 10 is connected to the terminal device 20 via, for example, a network. A plurality of terminal devices 20 may be provided. The number of terminal devices 20 can be appropriately set.

The code optimization system is, for example, a system that optimizes a code of a program. The code optimization system optimizes, for example, an operation-confirmed code. The code is, for example, a source code of a computer program executed in the information processing device. The operation-confirmed means that, for example, when a code is executed, it is confirmed that the code normally operates without generating an error and that correct output data can be obtained with respect to input data. Optimizing the code means, for example, changing at least part of the code in a state in which the code is executable. That is, the code optimization system optimizes the code by, for example, changing at least part of the code of the operation-confirmed program.

The code optimization system optimizes a code to be optimized using, for example, a language model. The language model outputs a code at least partially changed based on the optimization pattern using, for example, a prompt, an optimization pattern, and a code to be optimized as inputs. The prompt includes, for example, a sentence indicating optimization of the code. The optimization pattern is, for example, information indicating how to change a code in code optimization. The optimization pattern will be described later. The optimization pattern may also be included in the prompt. The language model can include, for example, a natural language model called a large-scale language model. An example of the language model will be described later.

Optimizing the code of the program means, for example, changing at least part of the code in order to improve the performance of the code or change the code according to the configuration of the information processing device. The code is optimized, for example, to improve execution performance of the code. That is, optimizing the code means correcting at least part of the code to execute the code.

The execution performance of the code is, for example, an index indicating efficiency at the time of executing the code. For example, the execution performance of the code is an execution time required at the time of executing the code. Optimizing the code when the execution performance of the code is the execution time is also referred to as speeding up the code. The execution performance of the code may be an index related to resources necessary for executing the code. For example, the smaller the resources required to execute the code, the higher the execution performance of the code. For example, the execution performance of the code includes at least one of an index related to a memory consumption amount at the time of executing the code and an index related to power consumption at the time of executing the code. The execution performance of the code is not limited to the above. The performance of the code may include, for example, an index indicating efficiency at the time of confirming or changing the code. For example, code performance may include code readability. The performance of the code is not limited to the above.

Changing the code according to the configuration of the information processing device means, for example, changing the code in such a way that the code operates in the information processing device in which the code is actually used. For example, changing the code according to the configuration of the information processing device means changing the code so as not to perform processing using a graphics processing unit (GPU) in order to operate in an information processing device not including the GPU in a case where processing using the GPU is required at the time of executing the code. Changing the code according to the configuration of the information processing device may be changing the code according to the specification of the operation system of the information processing device. Changing the code according to the configuration of the information processing device may be changing the code according to the specification of the program in which the code to be optimized is used in combination. Changing the code according to the configuration of the information processing device is not limited to the above.

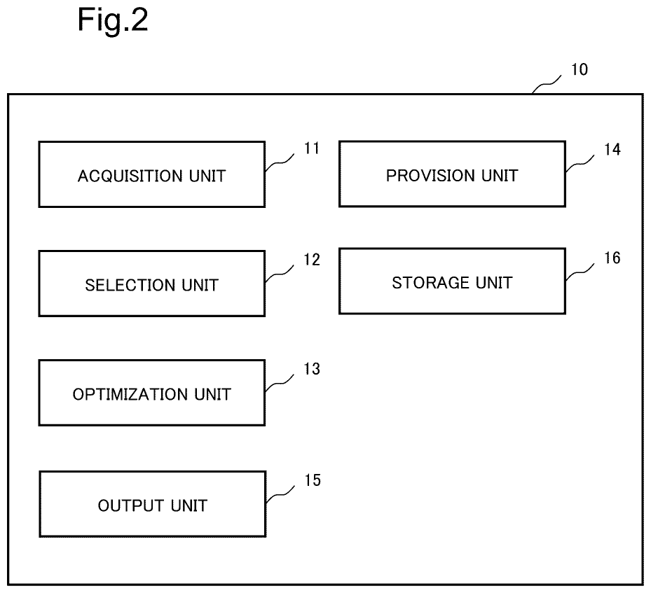

Here, an example of a configuration of the code optimization device 10 will be described. FIG. 2 is a diagram illustrating an example of a configuration of the code optimization device 10. The code optimization device 10 includes an acquisition unit 11, a selection unit 12, an optimization unit 13, and an output unit 15 as a basic configuration. The code optimization device 10 may include, for example, a provision unit 14 and a storage unit 16.

The acquisition unit 11 acquires a code, of a program, to be optimized. The code to be optimized is, for example, a code that has been confirmed to operate in the information processing device.

The code to be optimized is input to the terminal device 20 by, for example, a person in charge of optimizing the code. The acquisition unit 11 acquires a code to be optimized from the terminal device 20, for example. The acquisition unit 11 may acquire the code to be optimized via an input device (not illustrated) connected to the code optimization device 10. The code to be optimized may be stored in the storage unit 16.

The acquisition unit 11 may acquire a prompt used as an input to a language model for code optimization. In a case where the code generated by the optimization in the optimization unit 13 is further optimized, the acquisition unit 11 may acquire information indicating change content of the prompt.

The prompt or the change content of the prompt used as the input to the language model is input to the terminal device 20 by, for example, a person in charge of code optimization. The acquisition unit 11 acquires a prompt or change content of the prompt from the terminal device 20, for example. The acquisition unit 11 may acquire a prompt or change content of the prompt via an input device (not illustrated) connected to the code optimization device 10. The prompt used as an input to the language model may be stored in the storage unit 16.

The acquisition unit 11 may further acquire information about the attribute of the user. For example, the acquisition unit 11 acquires identification information about the user. The acquisition unit 11 acquires information about the attribute of the user based on the identification information about the user. The identification information about the user is acquired as, for example, login information to the code optimization system. The user is a person who uses the code optimization system. That is, the user is a person in charge of optimizing the code. The attribute of the user is, for example, the affiliation of the user. An example of the attribute of the user will be described later. The user may include a person belonging to an organization permitted to use the code optimization system. The relationship between the identification information about the user and the attribute of the user is stored, for example, in a storage means (not illustrated) of the code optimization system. The relationship between the identification information about the user and the attribute of the user may be stored in the storage unit 16.

The acquisition unit 11 may acquire a determination result for the code for which the optimization process has been performed. For example, the acquisition unit 11 acquires information indicating whether to use the code after optimization or to perform the optimization process again as the determination result for the code for which the optimization process has been performed. In a case where the optimization process is performed again, the acquisition unit 11 may acquire information indicating a code to be optimized. The information specifying the code to be optimized includes, for example, information indicating whether optimization is performed for the code before optimization or the code after optimization is further optimized.

The determination result for the code for which the optimization process has been performed is input by a person in charge of optimizing the code on the display screen of the terminal device 20 that displays the optimization result, for example. The acquisition unit 11 acquires, for example, a determination result for the code for which the optimization process has been performed from the terminal device 20.

In a case where the optimized code is stored as a new optimization pattern, the acquisition unit 11 may acquire information indicating a feature of the optimization pattern. The information indicating the feature of the optimization pattern is, for example, information indicating what kind of change has been made to the code to be optimized. The information indicating the feature of the optimization pattern is input to the terminal device 20 by, for example, a person in charge of code optimization. The acquisition unit 11 acquires, for example, information indicating the feature of the optimization pattern from the terminal device 20. The acquisition unit 11 may acquire information indicating the features of the optimization pattern via an input device (not illustrated) connected to the code optimization device 10. The code to be optimized may be stored in the storage unit 16.

The selection unit 12 selects an optimization pattern to be applied to a code to be optimized from the optimization pattern that is information indicating the content of optimization of a code. The optimization pattern is, for example, information about the content of optimization. The information about the content of optimization is, for example, information specifically indicating how to optimize the code. The information specifically indicating how to optimize the code is, for example, information indicating what kind of change has been made to the code in the optimization process of the code performed in the past. For example, the optimization pattern is information in which a code before optimization in a code optimization process is associated with a code after optimization. That is, the optimization pattern includes, for example, a code before optimization in a code optimization process and a code after optimization. In this case, the information about the content of optimization is, for example, a difference between the code before optimization and the code after optimization. For example, in a case where a change to a code that performs parallel processing is made to speed up the code, the optimization pattern is information in which a code before optimization that does not perform parallel processing is associated with a code after optimization that performs parallel processing. The optimization pattern may include the code before optimization and the code after optimization in the optimization work performed by programming by the person in charge of creating the code.

The optimization pattern may be information in which information indicating a portion changed by optimization and a code after the change at the portion is added to the code before optimization. The optimization pattern may be information in which information indicating the code before the change at the portion is added to the code after optimization. Information indicating the content of optimization may be added to the optimization pattern.

For example, the selection unit 12 selects the optimization pattern to be applied to the code to be optimized based on the similarity between the code to be optimized and the code before optimization included in the optimization pattern.

For example, the selection unit 12 changes a program to be optimized to a feature vector. For example, the selection unit 12 converts a program to be optimized into a feature vector using a language model. The selection unit 12 selects an optimization pattern to be applied to the code, of the program, to be optimized based on, for example, the feature vector converted from the program to be optimized and the feature vector converted from the code of the program before optimization included in the optimization pattern. For example, the selection unit 12 selects the optimization pattern to be applied to the code, of the program, to be optimized based on the Euclidean distance between the feature vector converted from the code, of the program, to be optimized and the feature vector converted from the code of the program before optimization included in the optimization pattern.

The selection unit 12 converts a code to be optimized and a code before optimization included in an optimization pattern into a feature vector using, for example, a language model. The selection unit 12 converts a program to be optimized into a feature vector using the language model. The converted feature vector is also referred to as an embedded representation. The language model for converting a code into a feature vector can include, for example, Word2 Vec. Examples of the large language model for converting a code into a feature vector may include Generative Pre-trained Transformer-2 (GPT-2), GPT-3, GPT-3.5, and GPT-4. Examples of the large language model for converting a code into a feature vector may include text-to-text transfer Transformer (T5), bidirectional encoder representations from transformers (BERT), robustly optimized BERT approach (ROBERTa), and efficiently learning an encoder that classifies token replacements accurately (ELECTRA). The language model that converts the code into the feature vector is not limited to the above.

The optimization pattern is stored in the storage unit 16, for example. The optimization pattern may be stored in the storage means outside the code optimization device 10. The code included in the optimization pattern may be stored in a state of being converted into a feature vector.

The selection unit 12 may select a plurality of optimization patterns as the optimization pattern to be applied to the code to be optimized. In this case, for example, the selection unit 12 selects an optimization pattern in which the similarity between the code before optimization included in the optimization pattern and the code to be optimized is equal to or higher than a reference as an optimization pattern to be applied to the code to be optimized. The similarity reference is set, for example, in such a way that the selected optimization pattern is suitable as an optimization pattern used for code optimization. The selection unit 12 may select, as an optimization pattern to be applied to the code to be optimized, optimization patterns having similarity from a high order to a predetermined order among optimization patterns in which the similarity between the code before optimization included in the optimization pattern and the code to be optimized is equal to or higher than a reference. The predetermined order is set, for example, based on the amount of data that can be handled as input data by a language model that performs the code optimization process.

The selection unit 12 may select an optimization pattern to be applied to the code to be optimized based on the use environment of the code of the program. The use environment is, for example, a configuration of an information processing device. For example, in a case where there is an optimization pattern to be optimized to perform processing using a GPU at the time of executing the code, when optimizing the code to be operated in an information processing device not including the GPU, the selection unit 12 does not select the code in which the optimization process is performed in such a way as to perform the processing using the GPU. In this case, the optimization pattern is associated with, for example, a constraint condition that the optimization pattern cannot be used for optimization of a code to be operated in an information processing device not including a GPU. The use environment of the code is not limited to the above.

The selection unit 12 may select an optimization pattern to be applied to a code to be optimized from among optimization patterns whose availability is set according to the attribute of the user. For example, the selection unit 12 selects an optimization pattern to be applied to a code to be optimized from among optimization patterns permitted to be used by the attribute of the user. The attribute of the user is, for example, an organization to which the user belongs. For example, in a case where the user belongs to the company A, the selection unit 12 selects an optimization pattern to be applied to a code to be optimized from among optimization patterns available to a person belonging to the company A. In this case, for example, the user belonging to the B company cannot use the optimization pattern available to the person belonging to the A company. For example, in a case where there is an optimization pattern generated based on the optimization of the code of the program related to the business of the company A, it is possible to keep the secret owned by the company A by only the user belonging to the company A using the pattern. The organization to which the user belongs may include an organization that entrusts the user with business. The attribute of the user may be a position, whether the user is a member, a rank of the member, whether the optimization pattern is created, a qualification, a nationality, or an age. The attribute of the user is not limited to the above.

In a case where the availability of the optimization pattern is set according to the attribute of the user, for example, the attribute of the user who can use the optimization pattern is set for each optimization pattern. In each optimization pattern, for example, information about an attribute is associated with an available user. Optimization patterns may be classified into groups, and available attributes may be set for each group. In a case where the attribute of the available user is set for each group of the optimization patterns, for example, information about the attribute is associated with the available user, for example, for each group of the optimization patterns. The selection unit 12 may select an optimization pattern to be applied to the code to be optimized from the optimization patterns stored in the storage area or the storage device according to the attribute of the user.

The selection unit 12 may select an optimization pattern to be applied to the code to be optimized from among the optimization patterns of the range based on the rank of the user. For example, the selection unit 12 selects an optimization pattern to be applied to a code to be optimized from among optimization patterns of the range based on the user rank. For example, in a case where the rank of the service is set according to the paid fee, it is assumed that the as the fee to be paid increases, the rank is raised, and the range of the optimization pattern that can be used increases. In this case, for example, the selection unit 12 selects an optimization pattern to be applied to a code to be optimized from among available optimization patterns according to the rank of the user. The rank of the user may be set based on the creation record of the optimization pattern. For example, the available range is set in such a way that a person who has created many optimization patterns has many available optimization patterns. The reference for setting the rank of the user is not limited to the above. The reference for setting the rank of the user can be appropriately set.

The optimization unit 13 optimizes the code to be optimized using the language model for optimizing the code based on a prompt for instructing optimization of the code of the program using the selected optimization pattern. The language model performs a process of changing at least part of the code based on the optimization pattern. The code generated in the processing in which the language model changes at least part of the code based on the prompt may also include a code whose performance is not improved as compared with the code before optimization.

The optimization unit 13 optimizes the code using the language model using, for example, a prompt for instructing optimization of the code and the optimization pattern as inputs of the language model. The language model is, for example, a machine learning model that outputs a code changed based on an optimization pattern with a prompt including a sentence instructing optimization of a code and a code to be optimized, and the optimization pattern as inputs. For example, the language model outputs a code optimized based on the optimization pattern and the prompt using a prompt including a sentence instructing optimization of a code of “Please optimize the following code with reference to the optimization pattern” and a code to be optimized, and an optimization pattern as inputs.

The optimization unit 13 may optimize the code using the language model using the prompt including the optimization pattern as an input of the language model. The language model is, for example, a machine learning model that outputs a code changed based on the prompt using a prompt including a code to be optimized as an input. For example, the language model outputs the optimized code based on the prompt using, as an input, a prompt including a sentence instructing optimization of a code of “Please optimize the code with reference to the following optimization patterns”, an optimization pattern, and a code to be optimized. The prompt may include a sentence instructing the content of the optimization process. For example, in a case where the optimization is performed in such a way that the processing of the code is speeded up as the optimization of the code, the optimization unit 13 may optimize the code using the prompt of “Please optimize the code with reference to the following optimization patterns” as the input of the language model.

The language model can include, for example, GPT-2, GPT-3, GPT-3.5, or GPT-4. Examples of the large language model may include T5, BERT, ROBERTa, and ELECTRA. The language model used for code optimization is not limited to the above. The language model for converting the code into the feature vector in the selection unit 12 and the language model used for code optimization may be the same language model, or may be different language models.

The optimization unit 13 may optimize the code to be optimized using a plurality of optimization patterns as inputs to the language model. In a case where a plurality of optimization patterns is used, the language model optimizes the code to be optimized with reference to the plurality of optimization patterns. In this case, how to reflect the content of the optimization in each of the plurality of optimization patterns in the optimization of the code is determined by the language model. Therefore, among the input optimization patterns, an optimization pattern that is not used for optimization of the actual code also occurs. In a case where a plurality of optimization patterns is used as an input to the language model, information specifying an optimization pattern to be emphasized may be included in the prompt.

The optimization unit 13 may optimize the code to be optimized using a prompt further including information indicating the feature of the optimization pattern associated with each optimization pattern as an input of the language model. The information indicating the feature of the optimization pattern is, for example, information indicating what kind of change has been made to the code to be optimized. The information indicating the feature of the optimization pattern may be information indicating the content of optimization suitable for application of the optimization pattern. The information indicating the feature of the optimization pattern may be, for example, information indicating the content of data to be processed at the time of executing the code. In this case, for example, when the optimization pattern is suitable for improving the processing speed of data in which text data and numerical data are mixed, the information indicating the feature of the optimization pattern is, for example, a sentence of “effective in the case of data having a property in which text and numerical values are mixed”. The information indicating the feature of the optimization pattern may be information indicating a degree of improvement in performance obtained by the optimization process using the optimization pattern. In this case, the information indicating the characteristic of the optimization pattern when the degree of improvement in performance is large is, for example, a sentence of “very effective and should be applied where applicable”. The information indicating the characteristic of the optimization pattern when the degree of improvement in performance is small is, for example, a sentence of “the priority of application is low since only small performance improvements are obtained”. The information indicating the feature of the optimization pattern is not limited to the above.

The optimization unit 13 may optimize the optimized code as a new optimization target again. In this case, the optimization patterns used for optimization may be the same optimization pattern, or may be the optimization pattern selected again in the selection unit 12. In a case where the optimization is performed again, the sentence indicating the optimization included in the prompt may be changed. Whether to optimize the code again is determined by, for example, a person in charge of creating the code.

The optimization unit 13 may perform optimization for the same code a plurality of times. In this case, for example, the optimization unit 13 performs optimization for the same code a plurality of times using the same prompt as an input of the language model. In a case where optimization is performed a plurality of times, whether to optimize the code again may be determined by, for example, a person in charge of creating the code.

The processing related to the optimization of the code may be performed in a device outside the code optimization device 10. In a case where the processing related to optimization of the code is performed in a device outside the code optimization device 10, the optimization unit 13 outputs, for example, a prompt including a sentence instructing optimization of the code and a code to be optimized, and an optimization pattern to an information processing device in which a language model that performs a process of optimizing the code operates. For example, the optimization unit 13 acquires the improved code from the information processing device that has optimized the code. The optimization pattern may also be included in the prompt.

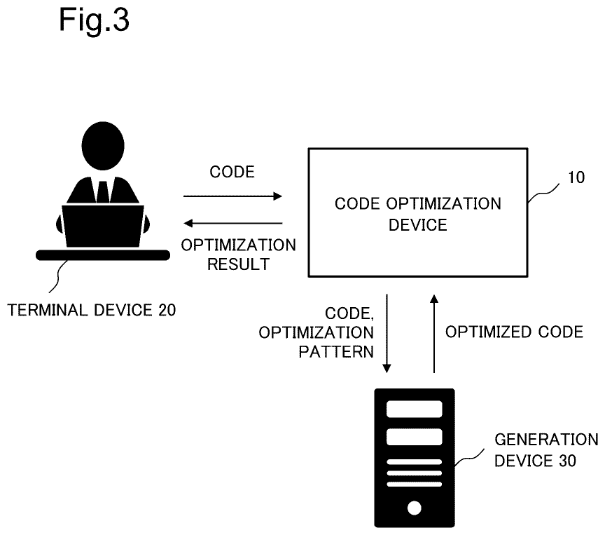

FIG. 3 illustrates an example of a configuration of a code optimization system that performs processing related to code optimization in the generation device 30 that is a device outside the code optimization device 10. In the example of FIG. 3, the code optimization device 10 is connected to a generation device 30 via, for example, a network. The generation device 30 is, for example, an information processing device that generates an optimized code from an input code using a language model. The optimization unit 13 outputs, for example, a prompt including a sentence instructing optimization of a code and a code to be optimized, and an optimization pattern to the generation device 30. The generation device 30 optimizes the code using, for example, a prompt including a sentence instructing optimization of the code and a code to be optimized, and an optimization pattern as an input of a language model. The optimization unit 13 acquires, for example, an optimized code.

For example, the provision unit 14 provides an incentive to the creator of the optimization pattern based on the number of times each optimization pattern is selected. For example, the provision unit 14 counts the number of times selected by the selection unit 12 for each optimization pattern. The incentive is granted by the provision unit 14 using, for example, money, points, or a right of use. The point is, for example, a point that can be allocated to the usage fee of the code optimization system. The point may be a point of an external point service. The point may be a point for determining the rank of the user. The use right is, for example, a right to use an optimization pattern in a code optimization system. The use right may be a right to use an optimization pattern that can be used only by a user of a higher rank. How to give an incentive can be appropriately set.

The output unit 15 outputs the optimized code. The output unit 15 outputs, for example, a code before optimization and a code after optimization. The output unit 15 may output the code before optimization and the code after optimization in a comparable state. For example, the output unit 15 outputs the optimized code in a state where the portion changed in the optimization process is easily visually recognized. For example, the output unit 15 outputs a code optimized in such a way that the color of the portion changed in the optimization process is displayed in a color different from the color of the portion not changed. The improvement of the visibility of the changed portion may be performed by other than the change in color. How to improve the visibility of the changed portion can be appropriately set.

The output unit 15 may output the code of the program before optimization and the code of the program after optimization in association with each other as a new optimization pattern. The output unit 15 outputs, for example, a display screen for selecting whether to use the optimized code. In a case where use of the optimized code is selected, the output unit 15 stores a new optimization pattern, for example, in the storage unit 16. The output unit 15 may output a new optimization pattern to an external storage device in which the optimization pattern is stored.

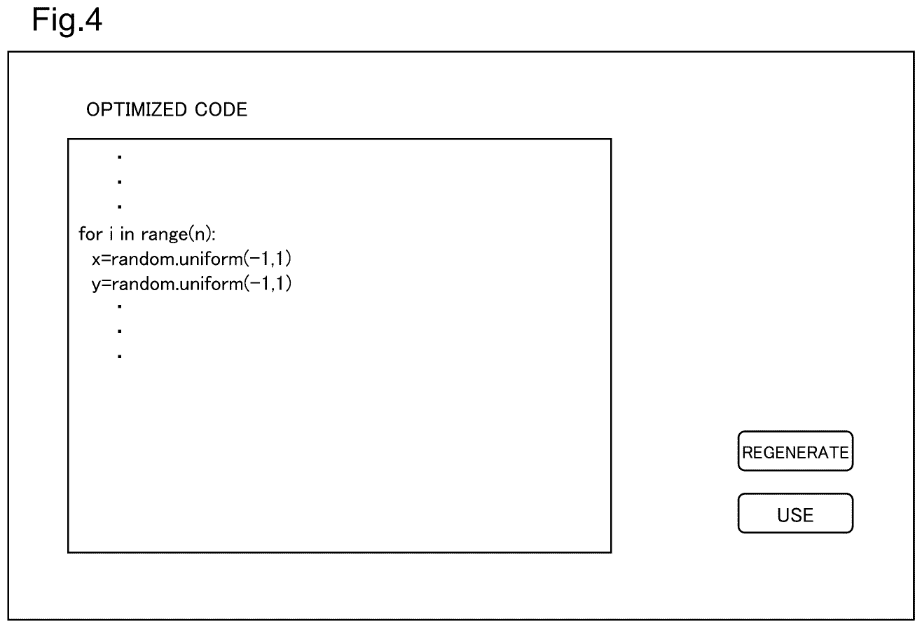

FIG. 4 is an example of a display screen of a code optimization result. In the example of the display screen of FIG. 4, the code after optimization process is performed is displayed in the field of “optimized code” on the left side. In the example of the display screen of FIG. 4, buttons of “regenerate” and “use” are displayed. In the example of the display screen of FIG. 4, in a case where the button of “regenerate” is pressed on the display screen, the optimization unit 13 performs the optimization process again for the code to be optimized, for example, using the language model. In this case, the optimization unit 13 optimizes the code, for example, using the optimization pattern same as the optimization pattern used in the optimization process of the code in which “regenerate” is selected. In the example of the display screen of FIG. 4, in a case where the button of “use” is pressed on the display screen, the output unit 15 stores the displayed code, for example, in the storage unit 16 as a result of optimization. In the example of the display screen in FIG. 4, when the button of “use” is pressed on the display screen, the output unit 15 stores the displayed code, for example, in the storage unit 16 as a code after optimization in association with the code before optimization as a new optimization pattern.

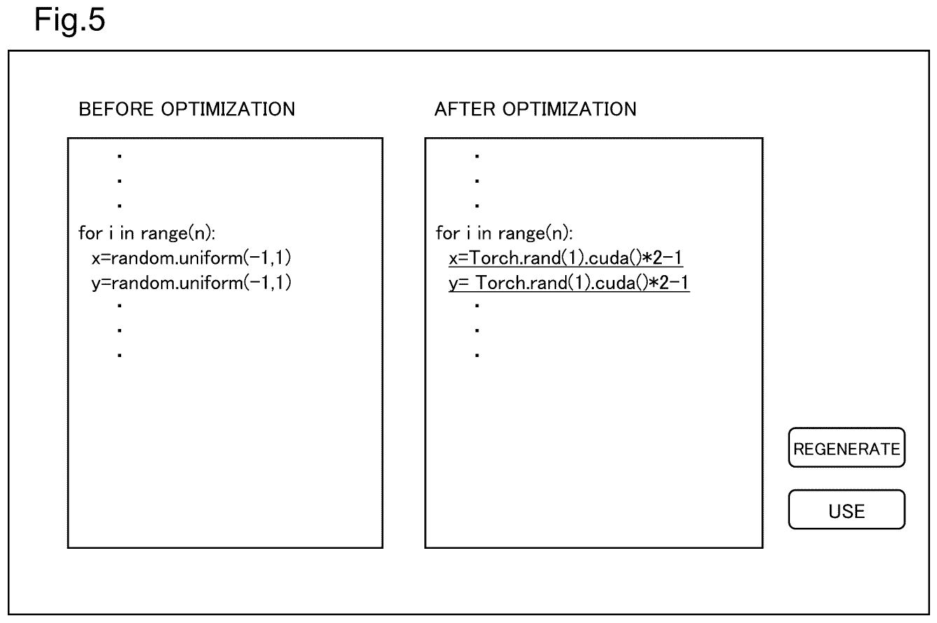

FIG. 5 is an example of a display screen displaying the code before optimization and the code after optimization as the optimization result of the code. In the example of the display screen of FIG. 5, the code before the optimization process is performed is displayed in the field of “before optimization”. In the example of the display screen of FIG. 5, the code after optimization process is displayed in the field of “after optimization”. In the example of the display screen of FIG. 5, underlines are displayed at the portions changed by the optimization process in the field of “after optimization”. In the example of the display screen of FIG. 5, buttons of “regenerate” and “use” are displayed. In the example of the display screen of FIG. 5, in a case where the button of “regenerate” is pressed on the display screen, the optimization unit 13 performs the optimization process again for the code before optimization, for example, using the language model. In this case, the optimization unit 13 optimizes the code, for example, using the optimization pattern same as the optimization pattern used in the optimization process of the code in which “regenerate” is selected. In the example of the display screen in FIG. 5, in a case where the button of “use” is pressed on the display screen, the output unit 15 stores the displayed code after optimization, for example, in the storage unit 16 as a result of optimization. In the example of the display screen of FIG. 5, when the button of “use” is pressed on the display screen, the output unit 15 stores the code after optimization and the code before optimization in association with each other, for example, in the storage unit 16 as a new optimization pattern.

The storage unit 16 stores, for example, data related to the optimization process of the code of the program. The storage unit 16 stores, for example, a code to be optimized. The storage unit 16 stores, for example, an optimization pattern. The storage unit 16 stores, for example, the code after optimization. The storage unit 16 stores, for example, an optimization pattern in which the code before optimization is associated with the code after optimization. The storage unit 16 stores, for example, a language model for performing the optimization process. The language model for performing the optimization process may be stored in a storage means outside the code optimization device 10.

The terminal device 20 is, for example, a terminal device used by a user of the code optimization system. The user of the code optimization system is, for example, a person in charge of creating a code of a program. The terminal device 20 acquires, for example, a code to be optimized input by a user's operation. The terminal device 20 outputs the code to be optimized to the acquisition unit 11 of the code optimization device 10, for example. The terminal device 20 acquires information about a code optimization result from the output unit 15 of the code optimization device 10, for example. The code optimization result is, for example, an optimized code. The terminal device 20 outputs information about the code optimization result to a display device (not illustrated), for example. The terminal device 20 can include, for example, a notebook personal computer or a desktop personal computer. The terminal device 20 is not limited to the above.

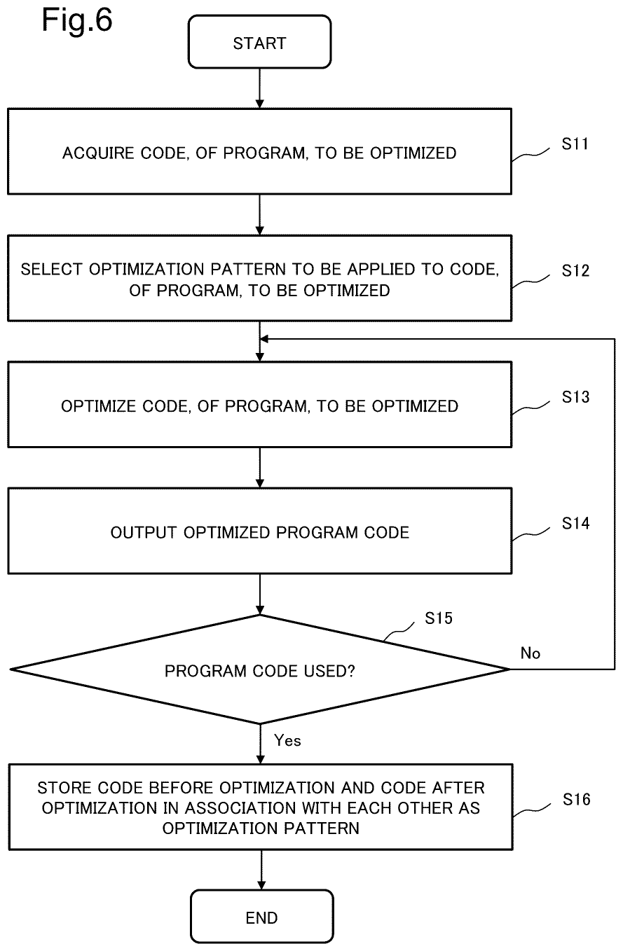

An example of the operation of the code optimization device 10 in the processing of optimizing the code of the program will be described. FIG. 6 illustrates an example of an operation flow in a process of improving the code of the program in the code optimization device 10.

The acquisition unit 11 acquires a code, of a program, to be optimized (step S11).

When the code is acquired, the selection unit 12 selects an optimization pattern to be applied to the code to be optimized from the optimization pattern that is information indicating the content of optimization of the code (step S12).

When the optimization pattern is selected, the optimization unit 13 optimizes the code to be optimized using the language model that performs processing based on the prompt based on the prompt instructing the optimization of the code using the selected optimization pattern (step S13).

When the code is optimized, the output unit 15 outputs the optimized code (step S14).

In a case where it is selected to use the output code when outputting the optimized code (Yes in step S15), the output unit 15 stores the optimized code and the code before optimization as a new optimization pattern (step S16).

In step S15, in a case where it is selected not to use the code (No in step S15), for example, the process returns to step S13, and the optimization unit 13 performs a process of optimizing the code to be optimized again.

The code optimization device 10 selects an optimization pattern to be applied to a code to be optimized from the optimization pattern. The code optimization device 10 optimizes the code using the language model based on the optimization pattern. As described above, by optimizing the code based on the optimization pattern, the person in charge of creating the code can optimize the code by suppressing the amount of programming for optimization performed by himself/herself. Therefore, the code of the program can be easily optimized by using the code optimization device 10.

For example, by associating the code before optimization in optimization of the code with the code after optimization, it is possible to generate an optimization pattern without requiring an operation of extracting change content by optimization. Therefore, the optimization pattern can be easily generated by using the code optimization device 10. By selecting the optimization pattern to be applied based on the similarity between the code before optimization included in the optimization pattern and the code to be optimized, the code optimization device 10 can easily select the optimization pattern suitable for the code to be optimized.

By setting whether to use the optimization pattern according to the attribute of the user, the code optimization device 10 can prevent information about a code that does not have a right from being used in optimization work by a person with an attribute that does not have a right for the code included in the optimization pattern, for example. Therefore, by using the code optimization device 10, for example, leakage of information about the code can be prevented.

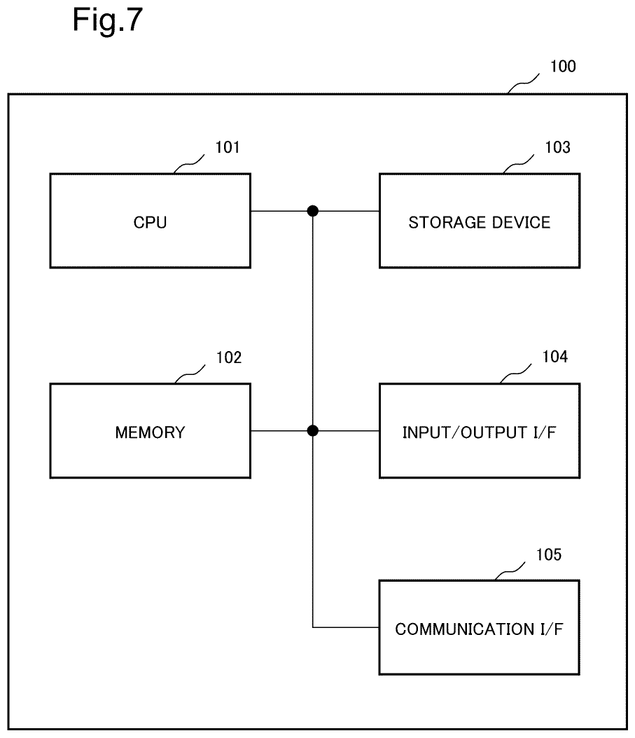

Each processing in the code optimization device 10 can be implemented by executing a computer program on a computer. FIG. 7 illustrates an example of a configuration of a computer 100 that executes a computer program for executing each processing in the code optimization device 10. The computer 100 includes a central processing unit (CPU) 101, a memory 102, a storage device 103, an input/output interface (I/F) 104, and a communication I/F 105.

The CPU 101 reads and executes a computer program for executing each processing from the storage device 103. The CPU 101 may be configured by a combination of a plurality of CPUs. The CPU 101 may be configured by a combination of the CPU and another type of processor. For example, the CPU 101 may be configured by a combination of a CPU and a GPU. The memory 102 includes a dynamic random access memory (DRAM) or the like, and temporarily stores a computer program executed by the CPU 101 and data being processed. The storage device 103 stores a computer program executed by the CPU 101. The storage device 103 includes, for example, a nonvolatile semiconductor storage device. The storage device 103 may include another storage device such as a hard disk drive. The input/output I/F 104 is an interface that receives an input from an operator to output display data and the like. The communication I/F 105 is an interface that transmits and receives data to and from the terminal device 20, the generation device 30, and other information processing devices. The terminal device 20 and the generation device 30 may have the same configuration as the computer 100.

The computer program used for executing each processing can also be distributed by being stored in a computer-readable recording medium that non-transiently records data. The recording medium can include, for example, a magnetic tape for data recording or a magnetic disk such as a hard disk. The recording medium may include an optical disk such as a compact disc read only memory (CD-ROM). A non-volatile semiconductor storage device may be used as a recording medium.

In the program used in the information processing device, for example, the processing time at the time of execution and the resources required at the time of execution may change depending on the quality of the code of the program. For example, the person in charge of creating the code optimizes the created code to suppress the processing time at the time of execution. On the other hand, code optimization may require a lot of workload and techniques related to optimization. For this reason, a system that supports creation of a code may be used. However, with the technology described in the background art, it may be difficult to perform optimization according to the code of the program.

Therefore, in order to solve the above problem, an object of the present disclosure is to provide a code optimization device and the like that can easily optimize a code of a program.

By using the code optimization device or the like of the present disclosure, the code of the program can be easily optimized.

Some or all of the above-described example embodiments may be described as the following Supplementary Notes, but are not limited to the following Supplementary Notes.

### [Supplementary Note 1]

A code optimization device including
an acquisition unit that acquires a code, of a program, to be optimized,
a selection unit that selects an optimization pattern to be applied to the code to be optimized from a plurality of optimization patterns that is information indicating content of optimization of a code,
an optimization unit that optimizes the code to be optimized using a language model that optimizes a code based on a prompt to instruct optimization of a code using the selected optimization pattern, and
an output unit that outputs the optimized code.

### [Supplementary Note 2]

The code optimization device according to Supplementary Note 1, wherein
the optimization pattern includes a code before optimization in a code optimization process and a code after optimization.

### [Supplementary Note 3]

The code optimization device according to Supplementary Note 2, wherein
the selection unit selects the optimization pattern to be applied to the code to be optimized based on similarity between the code to be optimized and a code before optimization included in the optimization pattern.

### [Supplementary Note 4]

The code optimization device according to Supplementary Note 3, wherein
the selection unit converts the code to be optimized into a feature vector, and selects the optimization pattern to be applied to the code to be optimized based on the converted feature vector and a feature vector converted from a code before optimization included in the optimization pattern.

### [Supplementary Note 5]

The code optimization device according to any one of Supplementary Notes 1 to 4, wherein
the optimization unit optimizes the code to be optimized using a prompt further including information indicating a feature of an optimization pattern associated with each of the optimization patterns as an input of the language model.

### [Supplementary Note 6]

The code optimization device according to any one of Supplementary Notes 1 to 4, wherein
the selection unit selects the optimization pattern to be applied to the code to be optimized from among optimization patterns of a range based on an attribute of a user.

### [Supplementary Note 7]

The code optimization device according to any one of Supplementary Notes 1 to 4, wherein
the selection unit selects the optimization pattern to be applied to the code to be optimized from among optimization patterns of a range based on a fee paid by a user.

### [Supplementary Note 8]

The code optimization device according to any one of Supplementary Notes 1 to 4, further including
a provision unit that provides an incentive to a creator of the optimization pattern based on the number of times each of the optimization patterns is selected.

### [Supplementary Note 9]

A code optimization method including
acquiring a code, of a program, to be optimized,
selecting an optimization pattern to be applied to the code to be optimized from a plurality of optimization patterns that is information indicating content of optimization of a code,
optimizing the code to be optimized using a language model that optimizes a code based on a prompt to instruct optimization of a code using the selected optimization pattern, and
outputting the optimized code.

### [Supplementary Note 10]

A non-transitory computer readable recording medium storing a code optimization program for causing a computer to execute the steps of
acquiring a code, of a program, to be optimized,
selecting an optimization pattern to be applied to the code to be optimized from a plurality of optimization patterns that is information indicating content of optimization of a code,
optimizing the code to be optimized using a language model that optimizes a code based on a prompt to instruct optimization of a code using the selected optimization pattern, and
outputting the optimized code.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Some or all of the configurations described as the Supplementary Notes can be similarly dependent on not only the Supplementary Notes 1, 9, and 10, but also various pieces of hardware and software, and various recording means or systems for recording software without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. A code optimization device comprising:
at least one memory storing instructions; and
at least one processor configured to access the at least one memory and execute the instructions to:
acquire a code, of a program, to be optimized;
select an optimization pattern to be applied to the code to be optimized from a plurality of optimization patterns that is information indicating content of optimization of a code;
optimize the code to be optimized using a language model that optimizes a code based on a prompt to instruct optimization of a code using the selected optimization pattern; and
output the optimized code.

2. The code optimization device according to claim 1, wherein
the optimization pattern includes a code before optimization in a code optimization process and a code after optimization.

3. The code optimization device according to claim 2, wherein
the at least one processor is further configured to execute the instructions to:
select the optimization pattern to be applied to the code to be optimized based on similarity between the code to be optimized and a code before optimization included in the optimization pattern.

4. The code optimization device according to claim 3, wherein
the at least one processor is further configured to execute the instructions to:
convert the code to be optimized into a feature vector; and
select the optimization pattern to be applied to the code to be optimized based on the converted feature vector and a feature vector converted from a code before optimization included in the optimization pattern.

5. The code optimization device according to claim 1, wherein
the at least one processor is further configured to execute the instructions to:
optimize the code to be optimized using a prompt further including information indicating a feature of an optimization pattern associated with each of the optimization patterns as an input of the language model.

6. The code optimization device according to claim 4, wherein
the at least one processor is further configured to execute the instructions to:
optimize the code to be optimized using a prompt further including information indicating a feature of an optimization pattern associated with each of the optimization patterns as an input of the language model.

7. The code optimization device according to claim 1, wherein
the at least one processor is further configured to execute the instructions to:
select the optimization pattern to be applied to the code to be optimized from among optimization patterns of a range based on an attribute of a user.

8. The code optimization device according to claim 4, wherein
the at least one processor is further configured to execute the instructions to:
select the optimization pattern to be applied to the code to be optimized from among optimization patterns of a range based on an attribute of a user.

9. The code optimization device according to claim 1, wherein
the at least one processor is further configured to execute the instructions to:
select the optimization pattern to be applied to the code to be optimized from among optimization patterns of a range based on a fee paid by a user.

10. The code optimization device according to claim 4, wherein
the at least one processor is further configured to execute the instructions to:
select the optimization pattern to be applied to the code to be optimized from among optimization patterns of a range based on a fee paid by a user.

11. The code optimization device according to claim 1, wherein
the at least one processor is further configured to execute the instructions to:
provide an incentive to a creator of the optimization pattern based on the number of times each of the optimization patterns is selected.

12. A code optimization method comprising:
acquiring a code, of a program, to be optimized;
selecting an optimization pattern to be applied to the code to be optimized from a plurality of optimization patterns that is information indicating content of optimization of a code,
optimizing the code to be optimized using a language model that optimizes a code based on a prompt to instruct optimization of a code using the selected optimization pattern; and
outputting the optimized code.

13. The code optimization method according to claim 12, wherein
the optimization pattern includes a code before optimization in a code optimization process and a code after optimization.

14. The code optimization method according to claim 13, further comprising
selecting the optimization pattern to be applied to the code to be optimized based on similarity between the code to be optimized and a code before optimization included in the optimization pattern.

15. The code optimization method according to claim 14, further comprising:
converting the code to be optimized into a feature vector; and
selecting the optimization pattern to be applied to the code to be optimized based on the converted feature vector and a feature vector converted from a code before optimization included in the optimization pattern.

16. The code optimization method according to claim 15, further comprising
optimizing the code to be optimized using a prompt further including information indicating a feature of an optimization pattern associated with each of the optimization patterns as an input of the language model.

17. The code optimization method according to claim 12, further comprising
selecting the optimization pattern to be applied to the code to be optimized from among optimization patterns of a range based on an attribute of a user.

18. The code optimization method according to claim 12, further comprising
selecting the optimization pattern to be applied to the code to be optimized from among optimization patterns of a range based on a fee paid by a user.

19. The code optimization method according to claim 12, further comprising
providing an incentive to a creator of the optimization pattern based on the number of times each of the optimization patterns is selected.

20. A non-transitory computer readable recording medium storing a code optimization program for causing a computer to execute the steps of:
acquiring a code, of a program, to be optimized;
selecting an optimization pattern to be applied to the code to be optimized from a plurality of optimization patterns that is information indicating content of optimization of a code;
optimizing the code to be optimized using a language model that optimizes a code based on a prompt to instruct optimization of a code using the selected optimization pattern; and
outputting the optimized code.
